(19) United States
(12) Patent Application Publication
(10) Pub. No.: US 2017/0170702 A1
(43) Pub. Date: Jun. 15, 2017

(54) SYSTEMS AND METHODS TO SEAL A ROTOR OR STATOR OF ELECTROMECHANICAL MOTORS OR GENERATORS

(71) Applicant: Baker Hughes Incorporated, Houston, TX (US)

(72) Inventors: Eckard Scholz, Eldingen (DE); Matthias Gatzen, Celle (DE); Sebastian Tegeler, Celle (DE)

(21) Appl. No.: 14/965,603

(22) Filed: Dec. 10, 2015

(51) Int. Cl. H02K 5/128; F01D 15/08; E21B 34/06; F01D 15/10; E21B 41/00; E21B 43/12

(52) U.S. Cl. CPC H02K 5/1285; E21B 41/0085; E21B 43/128; E21B 34/066; F01D 15/10; F01D 15/08; H02K 2005/1287

(57) ABSTRACT

A downhole system for use in a wellbore in a subterranean formation includes an electromechanical motor or generator. The electromechanical motor or generator may, respectively, be configured convert electricity to mechanical energy or convert mechanical energy in the form of fluid flow for use in one or more downhole tools. The electromechanical motor or generator includes one of a rotor and a stator disposed concentrically around and operatively coupled to the other of the rotor and the stator. A sleeve is disposed concentrically between the rotor and the stator. The sleeve contacts a body to enclose and hermetically seal one of the rotor and the stator therein. The sleeve comprises at least one metal portion and at least one non-magnetic and non-conductive portion. Related methods involve the formation of such a motor or generator.

### STATEMENT REGARDING FEDERALLY SPONSORED RESEARCH OR DEVELOPMENT

This Invention was made with government support under Contract No. DE_EE0005505 awarded by the United States Department of Energy. The Government has certain rights in the invention.

### TECHNICAL FIELD

Embodiments of the present disclosure relate generally to electromechanical motors for converting electrical energy into mechanical energy, and to electromechanical generators for converting mechanical energy into electrical energy. More particularly, this disclosure relates to electromechanical motors and generators for use in downhole tools that include a protective sleeve for hermetically sealing a rotor or stator therein.

### BACKGROUND

Wellbores are formed in subterranean formations for various purposes including, for example, extraction of oil and gas from subterranean formations and extraction of geothermal heat from subterranean formations. Electrical power is required for many operations performed downhole in conjunction with the formation and utilization of a subterranean wellbore. For example, during the formation of a wellbore, a bottom hole assembly (BHA) disposed at the distal end of a drill string may include various active components, including electromechanical tool components, sensors, and logging and telemetry equipment. Such active components may require power for operation. It may be difficult or uneconomical to convey electrical power to such active components in a wellbore from the surface of the formation. Thus, electromechanical generators have been developed for use downhole in wellbores to generate electrical power from the flow of drilling fluid or “mud” being circulated through the wellbore. These generators have commonly employed impellers or turbine rotors mounted in the flowline with the axis extending either parallel to or coincident with the axis of the flowline, to generate sufficient shaft horsepower to drive a conventional electrical generator. For example, shaft-driven brush commutated DC permanent magnet generators driven by coaxial mud turbines have been employed downhole in a pipe string to power logging, telemetry, and other equipment.

Similarly configured electromechanical motors have been developed for converting electrical energy either conveyed from the surface of the formation or generated downhole by a generator into mechanical energy for driving pumps, activating valves and operating other mechanical equipment.

The environmental conditions encountered downhole within a wellbore can be harsh in terms of pressure and temperature, and may involve exposure to chemically reactive fluids and gases. These conditions can lead to failure of downhole equipment, including electromechanical motors and generators.

### BRIEF SUMMARY

In some embodiments, an electromechanical motor or generator comprises a body, a first component disposed on the body, a second component disposed concentrically around and in operable proximity to the first component, and a sleeve disposed concentrically between the second component and the first component. The sleeve contacts the body such that the first component is hermetically sealed between the body and the sleeve. The first component comprises one of a rotor and a stator and one of a magnet and an electrical coil. The second component comprises the other of the rotor and the stator and the other of the magnet or the electrical coil. The sleeve comprises at least one metal portion and at least one non-magnetic and non-conductive portion.

Other embodiments comprise a downhole system for use in a wellbore in a subterranean formation. The downhole system comprises a hydraulic pump configured to pump fluid through the wellbore and an electromechanical generator configured to generate electricity responsive to flow of the fluid pumped through the wellbore by the hydraulic pump. The generator comprises a body, a first component disposed on the body, a drive element rotatable responsive to the flow of fluid, a second component disposed concentrically around, coupled to the drive element, and disposed concentrically around in operable proximity to the first component, and a sleeve disposed concentrically between the second component and the first component. The sleeve contacts the body such that the first component is hermetically sealed between the body and the sleeve. The first component comprises an electrical coil, and the second component comprises a magnet. The sleeve comprises at least one metal portion and at least one non-magnetic and non-conductive portion.

In yet other embodiments, the present disclosure comprises a method of forming an electromechanical motor or generator. A first component is disposed on a body. The first component comprises one of a rotor and a stator and one of a magnet and an electrical coil. A sleeve is disposed concentrically around the first component and hermetically seals the first component between the body and the sleeve. The sleeve comprises at least one metal portion and at least one non-magnetic and non-conductive portion. A second component may be disposed concentrically around the sleeve and the first component. The second component may be in operable proximity to the first component. The second component may comprise the other of the rotor and the stator and the other of the magnet and the electrical coil.

### BRIEF DESCRIPTION OF THE DRAWINGS

FIG. 1 illustrates a drilling system as described herein.

FIG. 2 illustrates a cross-sectional side view of an electromechanical generator disposed in a portion of the drilling system of FIG. 1.

FIG. 3 illustrates an enlarged view of the cross-sectional side view of the electromechanical generator of FIG. 2.

FIG. 4 illustrates a further enlarged view of the cross-sectional side view of the electromechanical generator of FIG. 2

FIG. 5 illustrates a cross-sectional view of a sleeve for use within the electromechanical generator of FIG. 2, according to an embodiment of the present disclosure.

FIG. 6 illustrates a cross-sectional side view of a portion of the sleeve of FIG. 3.

FIG. 7 illustrates a cross-sectional end view of a portion of the sleeve of FIG. 3.

FIG. 8 illustrates a cross-sectional side view of a sleeve for use within the electromechanical generator of FIG. 2, according to an embodiment of the present disclosure.

### DETAILED DESCRIPTION

The illustrations presented herein are not meant to be actual views of any particular component, device, or system, but are merely idealized representations which are employed to describe embodiments of the present invention.

As used herein, the term “and/or” includes any and all combinations of one or more of the associated listed items.

As used herein, relational terms, such as “upper,” “lower,” “first,” “second,” etc., are used for clarity and convenience in understanding the disclosure and accompanying drawings and does not connote or depend on any specific preference, orientation, or order, except where the context clearly indicates otherwise.

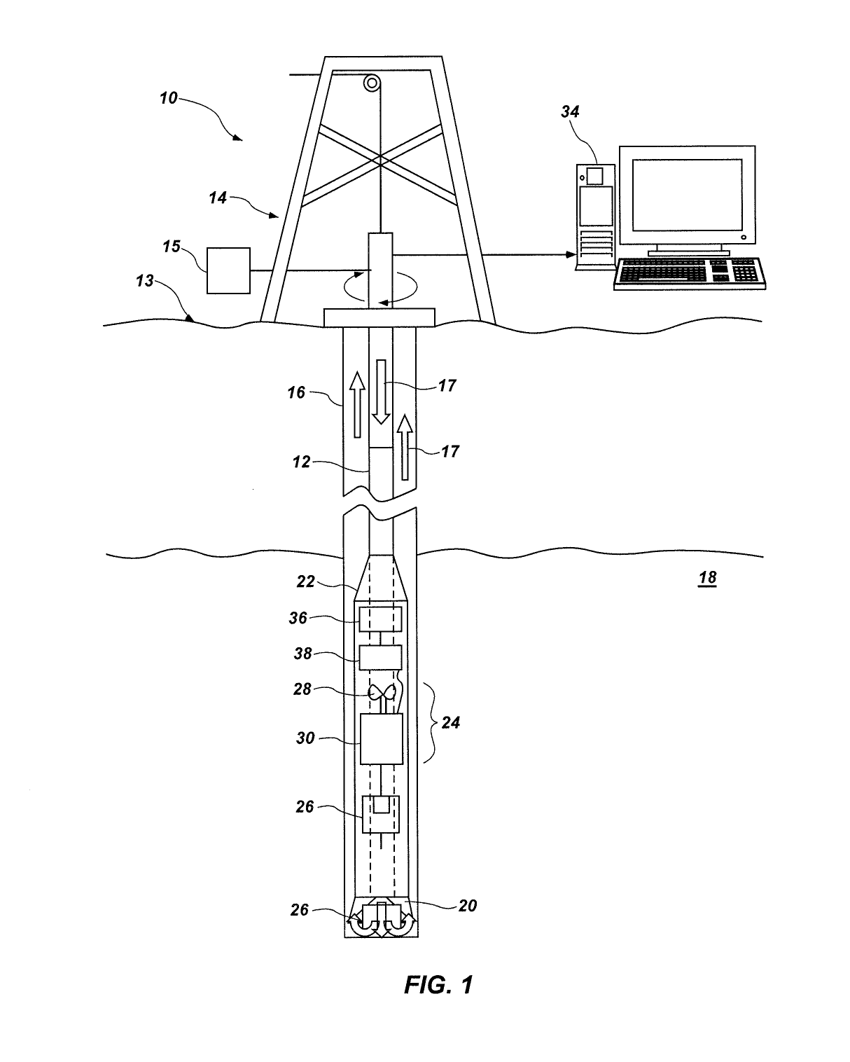

FIG. 1 illustrates a drilling system 10 comprising a drill string 12 extending from a drill rig 14 into a wellbore 16 formed in a subterranean formation 18. The drill rig 14 may be configured to conduct drilling operations such as rotating the drill string 12 and a drill bit 20 connected to a distal end of the drill string 12. The drill string 12 may comprise a downhole system, such as a bottom hole assembly (BHA) 22. The BHA 22 may comprise a system 24 configured for use in a downhole tool 26 and to provide or generate electricity for one or more downhole tools 26. The system 24 may comprise an electromechanical device in the form of a motor or generator 30. A hydraulic pump 15 located at a surface 13 of the formation 18 may be configured to pump fluid (e.g. drilling mud) through the wellbore 16 and through or around the electromechanical generator 30 to generate electricity. In some embodiments, the system 24 may comprise an electromechanical generator 30 that includes a mud-turbine 28 configured to convert fluid flow generated by the hydraulic pump 15 into rotational energy. The electromechanical generator 30 may be configured to convert the rotational energy into electrical energy so as to generate electricity responsive to the flow of fluid pumped through the wellbore 16 by the hydraulic pump 15. The drilling system 10 may also comprise information processing devices such as a computer processing system 34 located at the surface 13 in communication with one or more devices in the BHA 22, such as a mud-puller 36 and puller-actuator 38. In other embodiments, the electromechanical device may comprise a motor configured to convert electrical energy to mechanical energy to, for example, drive an hydraulic pump or operate a valve or other assembly including one or more moveable components.

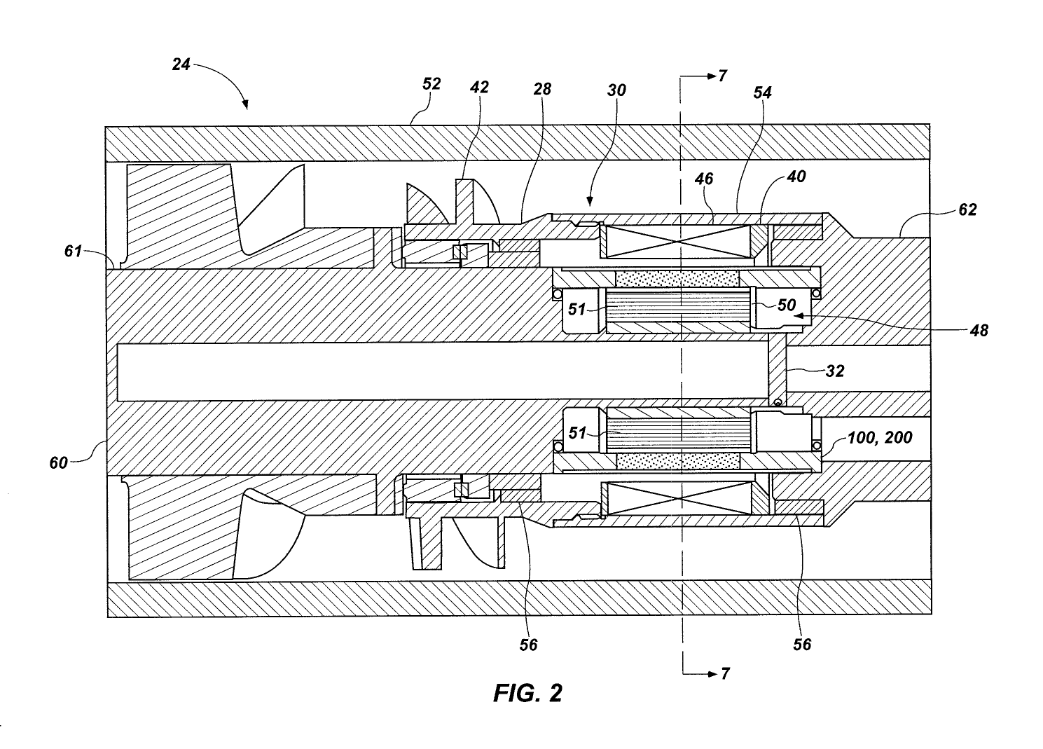

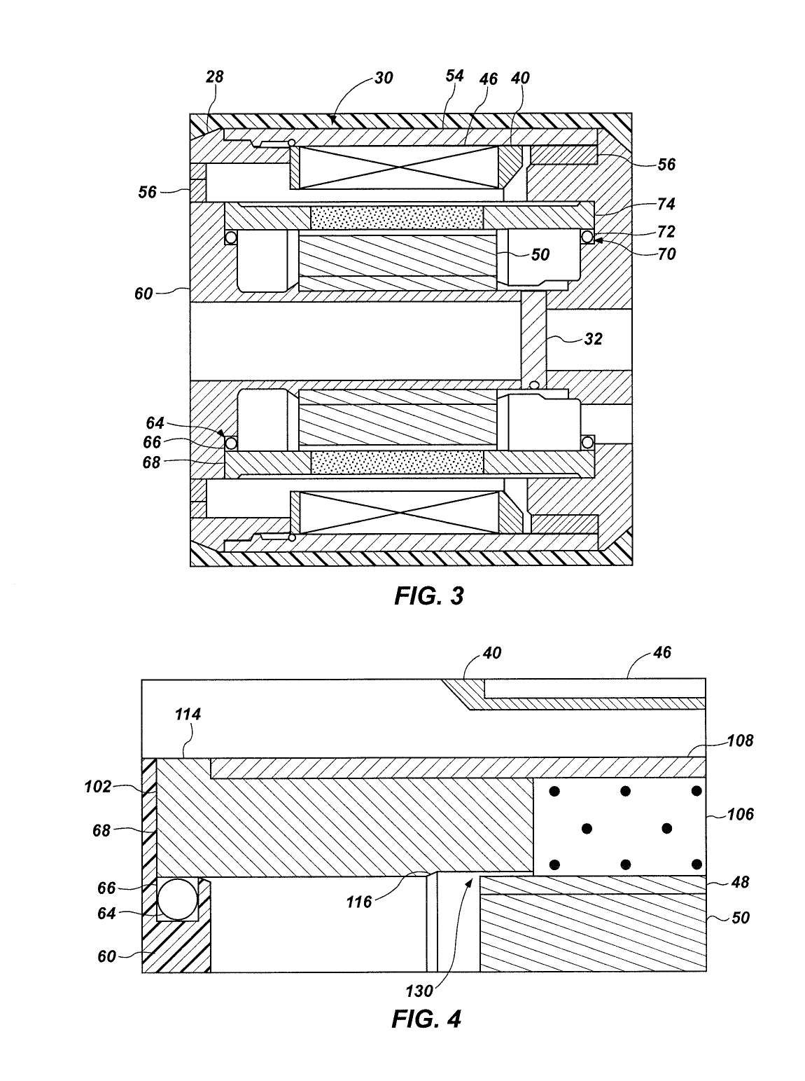

FIG. 2 illustrates a cross-sectional side view of an embodiment of an electromechanical motor or generator 30 that may be employed in the drilling system 10 of FIG. 1 in accordance with the present disclosure. As shown in FIG. 2, the motor or generator 30 includes a protective sleeve 100, 200 described in further detail herein. FIGS. 3 and 4 illustrate enlarged views of the cross-sectional side view of the electromechanical generator 30 of FIG. 2.

The non-limiting embodiment of the motor or generator 30 illustrated in FIGS. 2 through 4 is a generator that includes a drive element rotatable responsive to flow of fluid therepast, for example, a mud-turbine 28, in combination with a first component and a second component. The first component may comprise one of a rotor 40 and a stator 48, and the second component may comprise the other of the rotor 40 and the stator 48. The rotor 40 and the stator 48 may be in mutual operable proximity for generation of electricity. The generator 30 employs the fluid flowing through the wellbore to cause rotation of the mud-turbine 28, which is mechanically coupled to the rotor 40. Rotation of the rotor 40 relative to the stationary stator 48 generates electricity in accordance with well-known principles of operation of a conventional electromechanical generator.

Referring to FIGS. 2 and 3, the generator 30 includes a central body 60. The rotor 40 and the stator 48 are mounted on the central body 60. In the electromechanical motor or generator 30, the rotating component(s) may be collectively termed the “rotor,” which may comprise one of a magnet and an electrical coil, and the stationary components may be collectively termed the “stator,” which may comprise the other of the magnet and the electrical coil.

As a non-limiting example, a plurality of permanent magnets 46 may be embedded in the rotor 40. The rotor 40 may be disposed concentrically around and may be in operable proximity with the stator 48. In other embodiments, the stator 48 may be disposed concentrically around and may be in operable proximity with the rotor. The stator 48 may comprise one or more electrical coils 51 (i.e., electrically conductive wire(s) wound into cone or more coils) wrapped around fins 58 of a winding stack 50 of the stator 48 (FIG. 7). The stator 48 may be disposed on the central body 60 between an upper portion 61 and a lower portion 62 of the central body 60. The stator 48 may be coupled to the lower portion 62 of the central body 60 by a welding sleeve 32. The lower portion 62 may be coupled, for example, to a downhole tool 26 that may employ the electrical power generated by the generator 30. Electrical wiring operatively coupled to the electrical coil(s) 51 of the stator 48 may extend through the lower portion 62 to provide electricity to the at least one downhole tool 26, which may be operatively and/or mechanically coupled to the lower portion 62. A sleeve 100, 200 as previously referenced may be disposed concentrically between the rotor 40 and the stator 48.

In some embodiments, the sleeve 100 may be connected to the central body 60 such that the stator 48 is hermetically sealed between the central body 60 and the sleeve 100. The stator 48 may be disposed between the central body 60 and the sleeve 100. For example, during formation of the generator 30 at the surface 13 of the formation 18, the stator 48 may be disposed between the central body 60 and the sleeve 100 so as to hermetically seal the stator 48 between the central body 60 and the sleeve 100 at atmospheric pressure (e.g., approximately 1 bar). To create the hermetic seal, a first seal member 64 (e.g., O-ring) may be disposed in a first annular seal groove 66 disposed between a first longitudinal end 68 of the sleeve 100 and the central body 60, and a second seal member 70 (e.g., O-ring) may be disposed in a second annular seal groove 72 disposed between a second longitudinal end 74 of the sleeve 100 and the central body 60.

During operation, fluid may flow downwardly through the drill string 12 and upwardly through the annulus of the wellbore 16 in the directions shown by arrows 17 in order to lubricate the drill bit 20 and flush cuttings from the wellbore 16 (FIG. 1). Fluid pumped through the drill string 12 may be forced into and flow through blades 42 (FIG. 2) of the mud-turbine 28 causing the blades 42 to rotate. The mud-turbine 28 is coupled to the rotor 40 such that the rotation of the mud-turbine 28 mechanically drives rotation of the rotor 40. The rotor 40 may rotate about the stator 48. Rotation of the permanent magnets 46 creates a rotating magnetic field that is used to induce current flow in the electrical coil(s) 51 to generate electricity that may be employed by another downhole tool 26.

After passing through the blades 42 of the turbine 38, fluid may flow between an inner surface of housing 52 of the BHA 22 and an outer surface of housing 54 of the downhole generator 30. In other embodiments, fluid may flow around and along an inner surface of the generator housing 54 such that the rotor 40 and bearings 56, which may be lubricated by the fluid, may run in drilling fluid. The protective sleeve 100, 200 prevents the fluid flowing through the generator 30 from contacting stator 48 as the stator 48 is hermetically sealed between the central body 60 and the sleeve 100.

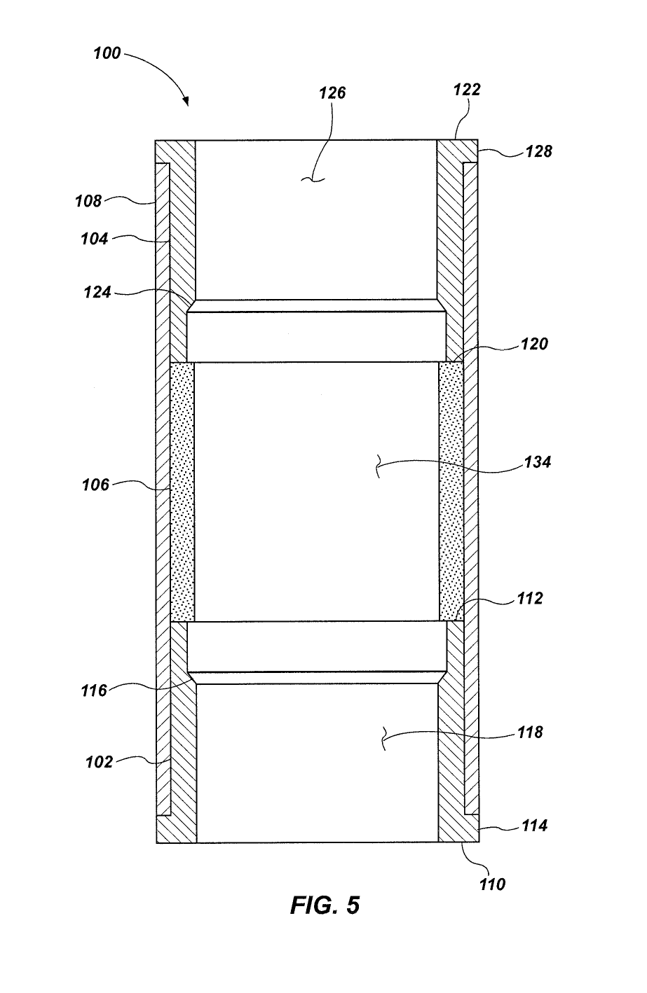

FIG. 5 illustrates a cross-sectional side view of a sleeve 100 according to an embodiment of the present disclosure. The sleeve 100 may comprise at least one metal portion and at least one non-magnetic and electrically non-conductive portion. As used herein, the term “non-magnetic” means and includes a material having a value of magnetic permeability less than 1.01 H/m at 200 oersted (15.9 kA/m). As used herein, the term “non-conductive” means and includes a material having a value of electrical resistivity extending in a range from about 10⁸ Ω-m to about 10¹⁷ Ω-m. In some embodiments, the at least one non-conductive and non-magnetic portion comprises a polymer or a ceramic material. As illustrated in FIG. 2, the at least one non-magnetic and non-conductive portion comprises a ceramic tube 106. The stator 48 may be disposed at least substantially within the ceramic tube 106. In other embodiments, the rotor 40 may be disposed at least substantially within the ceramic tube 106. By way of non-limiting example, the ceramic tube 106 may comprise a ceramic material such as zirconium oxide. In some embodiments, the ceramic tube 106 may have an average thickness in a range extending from about 6 mm to about 10 mm and, more particularly, may have an average thickness of about 8 mm.

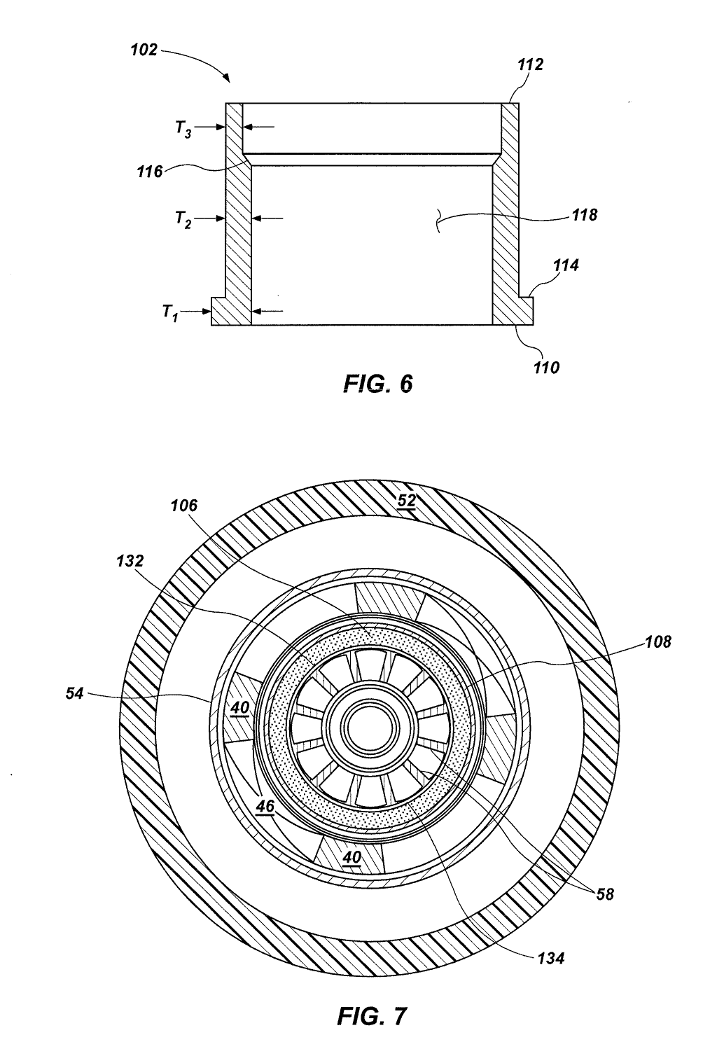

In some embodiments, the at least one metal portion may comprise a first longitudinal metal end portion 102 and a second longitudinal metal end portion 104. The ceramic tube 106 may extend longitudinally between the first longitudinal metal end portion 102 and the second longitudinal metal end portion 104. FIG. 6 illustrates a cross-sectional side view of the first longitudinal metal end portion 102 of FIG. 5. The first longitudinal metal end portion 102 may exhibit a varying wall thickness between a first longitudinal end 110 and a second longitudinal end 112 thereof. The first longitudinal metal end portion 102 may comprise a shoulder 114 proximate to the first longitudinal end 110 thereof. The shoulder 114 may be configured to abut against and support a metal tube 108 during assembly of the sleeve 100. The shoulder 114 may define a first wall thickness T₁ of the first longitudinal metal end portion 104. The first longitudinal metal end portion 104 may have a second wall thickness T₂ between the shoulder 114 and an annular tapered groove 116. The second wall thickness T₂ may be less than the first wall thickness T₁. The annular tapered groove 116 may be formed along a circumference of an inner side surface 118 of the first longitudinal metal end portion 102. The annular tapered groove 116 may be configured to gradually reduce the thickness of the wall of the first longitudinal metal end portion 102 proximate to the second longitudinal end 112 thereof. Although the transition between the second wall thickness T₂ and the third wall thickness T₃ is shown in FIGS. 5 and 6 as a tapered transition, the present disclosure is not so limited. For example, the transition between the second wall thickness T₂ and the third wall thickness T₃ may be at least one of single stepped, multi stepped, or curved. The third wall thickness T₃ may be less than the first wall thickness T₁ and the second wall thickness T₂.

While FIG. 6 illustrates the first longitudinal metal end portion 102 of the sleeve 100, the first and second longitudinal metal end portions 102, 104 may comprise substantially the same design and configuration. For example, a cross-sectional view of the second longitudinal metal end portion 104 would simply be an inverted-view of the first longitudinal metal end portion 102. The second longitudinal metal end portion 104 may exhibit varying wall thicknesses between a first longitudinal end 120 and a second longitudinal end 122 thereof. The second longitudinal metal end portion 104 may comprise an annular tapered groove 124 along a circumference of an inner side surface 126 proximate to the first longitudinal end 120 and may comprise a shoulder 128 at the second longitudinal end 122 thereof. The wall thickness may be reduced proximate to the first longitudinal end 120 of the second longitudinal metal end portion 104. In some embodiments, the average thickness of the first and second longitudinal metal end portions 102, 104 may be in a range extending from about 3 mm to about 8 mm, and more particularly, from about 4 mm to about 6 mm.

The reduced wall thickness proximate to the second longitudinal end 112 of the first longitudinal metal end portion 102 and proximate to the first longitudinal end 120 of the second longitudinal metal end portion 104 may be configured to provide an air gap 130 between inner surfaces 118, 126 of the first and second longitudinal metal end portions 102, 104 and an outer surface 132 of fins 58 of the winding stack 50, which may be laminated (FIG. 4). The air gap 130 may be provided to prevent short-circuiting of the generator 30 caused by contact of the first and second longitudinal metal end portions 102, 104 and the winding stack 50 and to prevent generation of eddy current losses on the outer surface 132 of the fins 58 of the winding stack 50. In some embodiments, the air gap 130 may be in a range extending from about 1 mm to about 5 mm, and more particularly, from about 2 mm to about 4 mm.

The first longitudinal metal end portion 102 and the second longitudinal metal end portion 104 may comprise a metal or metal alloy exhibiting weak magnetic and electrical properties (relative to other metals and metal alloys). By way of non-limiting example, the materials comprising the first and second longitudinal metal end portions 102, 104 may be selected from at least one of a titanium-based alloy, a nickel-based alloy, such as INCONEL®, or a non-magnetic steel, such as stainless steel. In some embodiments, the first and second longitudinal metal end portions 102, 104 may be formed of the same metallic material. In other embodiments, the first and second longitudinal metal end portions 102, 104 may be formed of different metallic materials.

In some embodiments, the at least one metal portion may also comprise the metal tube 108. The metal tube 108 may be disposed concentrically around the first longitudinal metal end portion 102, the second longitudinal metal end portion 104, and the ceramic tube 106. The metal tube 108 may extend longitudinally between the first longitudinal metal end portion 102 and the second longitudinal metal end portion 104 and abut against the shoulders 114, 128 thereof. The metal tube 108 may be bonded to the first longitudinal metal end portion 102 and the second longitudinal metal end portion 104 such that the ceramic tube 106 may be captured and enclosed within the metal portion of the sleeve 100. The ceramic tube 106 may be retained between the first longitudinal metal end portion 102 and the second longitudinal metal end portion 104 and within the metal tube 108 that is coupled to the metal end portions 102, 104. In some embodiments, the metal tube 108 may be mechanically coupled to the first and second longitudinal metal end portions 102, 104 by bolts, pins, screws, or the like. In other embodiments, the metal tube 108 may be bonded to the upper and first longitudinal metal end portions 102, 104 by welding, such as electron beam welding, brazing, and the like.

In some embodiments, the ceramic tube 106 may not be bonded to the metal tube 108, although an outer surface of the ceramic tube 106 may abut against and be supported by an inner surface of the metal tube 108. An inner surface 134 of the ceramic tube 106 may abut against and be supported by the outer side surface 132 of at least one fin 58 of the winding stack 50, as illustrated in FIG. 7. In other embodiments, the ceramic tube 106 may not be supported by the outer side surface 132 of at least one fin 58 of the winding stack 50.

In some embodiments, the average thickness of the metal tube 108 may be less than the average thickness of the ceramic tube 106. As a non-limiting example, an average thickness of the metal tube 108 may be in a range extending from about 0.5 mm to about 2 mm (e.g., about 1 mm). The metal tube 108 may comprise a metal or metal alloy. By way of example and not limitation, the metal tube 108 may be formed of a material selected from at least one of a titanium-based alloy, a nickel-based alloy, such as INCONEL®, or a non-magnetic steel, such as stainless steel.

It may be desirable to substantially match the coefficients of thermal expansion of the various components of the sleeve 100. For example each of the metal portions 102, 104, 108 of the sleeve 100 may comprise materials having a first linear coefficient of thermal expansion at room temperature, and each ceramic tube 106 of the sleeve 100 may comprise a material having a second linear coefficient of thermal expansion at room temperature. The second linear coefficient of thermal expansion may be between about 90% and about 110% of the first linear coefficient of thermal such that each portion of the sleeve 100 may expand and contract at substantially similar rates as temperatures of the sleeve 100 vary during operation. The sleeve 100 may be exposed to elevated temperatures of approximately 300° C. or more during use. By way of non-limiting example, each portion of the sleeve 100 may be formed from a material exhibiting a linear coefficient of thermal expansion in a range extending from about 7 μm/m° C. and about 15 μm/m° C. and, more particularly, from about 9 μm/m° C. to about 13 μm/m° C.

Alternatively or additionally, each metal portion 102, 104, 108 of the sleeve 100 has a first modulus of elasticity, and each ceramic tube 106 of the sleeve 100 has a second modulus of elasticity. The second modulus of elasticity may be between about 90% and about 110% of the first modulus of elasticity such that each portion may be similarly resistant to deformation by forces created by the pressure differential existing between the pressure internal to the sleeve 100 and the pressure external to the sleeve 100. By way of non-limiting example, each portion of the sleeve 100 may be formed from a material exhibiting a modulus of elasticity in a range extending from about 170 GPa to about 230 GPa and, more particularly, from about 190 GPa to about 210 GPa.

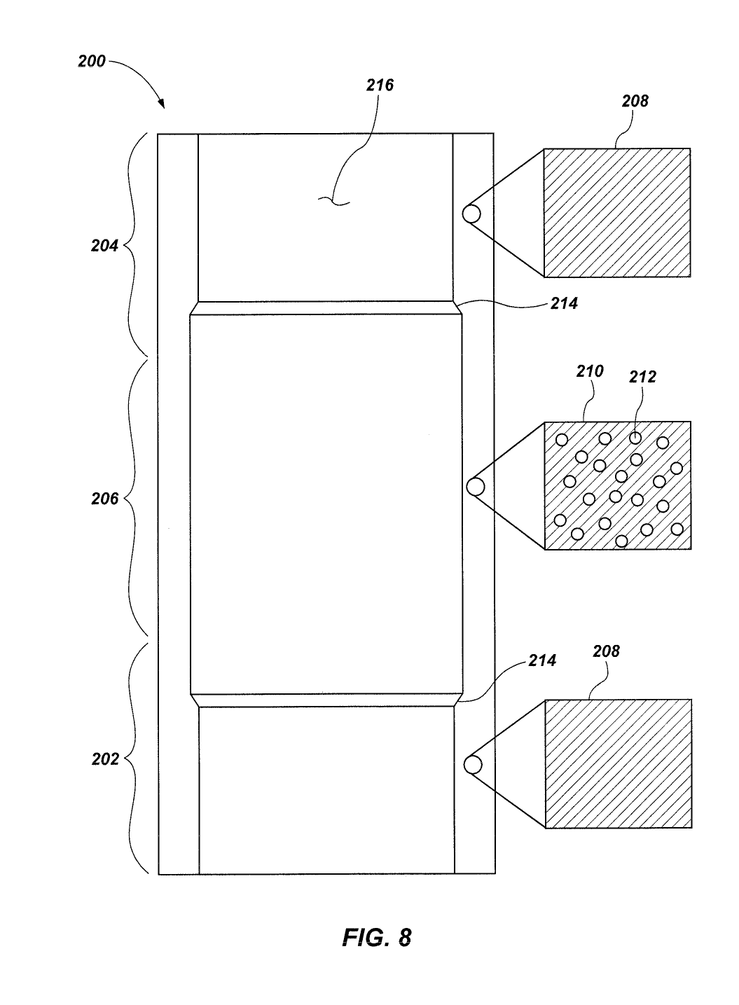

FIG. 8 illustrates a sleeve 200 according to an additional embodiment of the present disclosure. The sleeve 200 may have a shape as described in relation to the sleeve 100, and may be employed in the generator or motor 30 in the same manner as described in relation to the sleeve 100. In the embodiment of FIG. 8, however, the sleeve 200 comprises a single unitary body instead of separate components that are separately formed and then assembled and coupled together. In such an embodiment, the sleeve 200 may comprise a ceramic-metal composite material. The metal portion of the sleeve may comprise a metal phase of the ceramic-metal composite material, and the ceramic portion of the sleeve may comprise a ceramic phase of the ceramic-metal composite material.

In some embodiments, the sleeve 200 may comprise a first longitudinal end portion 202, and a second longitudinal end portion 204, and a central portion 206. In some embodiments, the central portion 206 may comprise the ceramic-metal composite material, and the end portions 202, 204 may be at least substantially comprised of a metal or metal alloy. The ceramic-metal composite material may comprise a continuous metal phase 210 and a discontinuous ceramic phase 212. In some embodiments, the discontinuous ceramic phase 212 may comprise ceramic particles (e.g., round particles or elongated whiskers or fibers) dispersed in a metallic binder. The ceramic particles 212 may comprise a non-magnetic and electrically non-conductive material. In some embodiments, the ceramic-metal composite material may comprise a cemented tungsten carbide composite material in which ceramic tungsten carbide particles are embedded in a tungsten metal alloy binder.

The first and second longitudinal end portions 202, 204 may comprise an annular tapered groove 214 formed along a circumference of an inner surface 216 thereof. The annular tapered groove 214 may be formed on each of the first and second longitudinal end portions 202, 204 proximate to the central portion 206. The annular tapered groove may be configured to gradually reduce the thickness of the wall of the first and second longitudinal end portions 202, 204. The thickness of the wall of the first and second longitudinal end portions 202, 204 and the thickness of the wall of the central portion 206 may be configured to provide an air gap between an inner surface of the sleeve 200 and the outer surface of the fins 58 of the winding stack 50 of the stator 48, which may be enclosed by the sleeve 200 and the central body 60, as previously described in relation to the sleeve 100.

By way of example and not limitation, the sleeve 100, 200 of the present disclosure may provide certain advantages over conventional sleeves in electromechanical motors and generators. Sleeves in electromechanical motors and generators may be subject to a high pressure differential and high operating temperatures, thereby limiting the minimal thickness and materials appropriate for construction of the sleeve. Conventional protective sleeve assemblies therefore comprise a singular, metallic sleeve. However, eddy currents may be induced in the protective sleeve by the rotating magnetic field generated by interaction of the rotor 40 and stator 48. In operation, such eddy current losses may heat windings in the stator 48, which may severely reduce the efficiency of the generator 30, and may heat the material comprising the sleeve. Eddy current losses may be intensified due to the electrical conductivity of the materials comprising the conventional sleeve. Eddy current losses are nearly proportional to the thickness of the sleeve and to the electrical conductivity of the materials comprising the sleeve. In order to reduce eddy current losses, it may be desirable to reduce the thickness of the sleeve and to use alternative materials with lower electrical conductivity. The sleeve 100, 200 of the present disclosure comprises a ceramic portion including an electrically non-conductive and non-magnetic material to reduce eddy current losses. Further, the thickness of each of the metal portions of the sleeve 100, 200 may be minimized to further reduce eddy current losses. The protective sleeves 100, 200 as described herein may exhibit sufficient mechanical strength and toughness to withstand the pressures and conditions encountered during use, while having compositions that reduce or minimize losses in efficiency resulting from induced eddy currents in the sleeves 100, 200.

Additional non-limiting example embodiments of the disclosure are described below.

### Embodiment 1

An electromechanical motor or generator, comprising a body, a first component disposed on the body, a second component disposed concentrically around and in operable proximity to the first component, and a sleeve disposed concentrically between the second component and the first component and contacting the body such that the first component is hermetically sealed between the body and the sleeve. The first component comprises one of a rotor and a stator and comprises one of a magnet and an electrical coil. The second component comprises the other of the rotor and the stator and comprises the other of the magnet and the electrical coil. The sleeve comprises at least one metal portion and at least one non-magnetic and non-conductive portion.

### Embodiment 2

The electromechanical motor or generator of Embodiment 1, wherein the at least one non-magnetic and non-conductive portion comprises a ceramic tube, and therein the first component is disposed at least substantially within the ceramic tube.

### Embodiment 3

The electromechanical motor or generator of Embodiment 1 or 2, wherein the at least one metal portion comprises a metal tube disposed concentrically about the ceramic tube.

### Embodiment 4

The electromechanical motor or generator of any of Embodiments 1 through 3, wherein the at least one metal portion further comprises a first longitudinal metal end portion and a second longitudinal metal end portion, and wherein each of the ceramic tube and the metal tube extends longitudinally between the first longitudinal metal end portion and the second longitudinal metal end portion.

### Embodiment 5

The electromechanical motor or generator of any of Embodiments 1 through 4, wherein each of the first longitudinal metal end portion and the second longitudinal metal end portion is bonded to the metal tube such that the ceramic tube is captured and enclosed within the metal portion of the sleeve.

### Embodiment 6

The electromechanical motor or generator of any of Embodiments 1 through 5, wherein the at least one metal portion of the sleeve has a first linear coefficient of thermal expansion at room temperature, the at least one non-magnetic and non-conductive portion of the sleeve has a second linear coefficient of thermal expansion at room temperature, the second linear coefficient of thermal expansion being between about 90% and 110% of the first linear coefficient of thermal expansion.

### Embodiment 7

The electromechanical motor or generator of any of Embodiments 1 through 6, further comprising a first seal member disposed between a first longitudinal end of the sleeve and the body, and a second seal member disposed between a second longitudinal end of the sleeve and the body.

### Embodiment 8

The electromechanical motor or generator of Embodiment 1, wherein the non-magnetic and non-conductive portion of the sleeve comprises a ceramic portion or a polymer portion.

### Embodiment 9

The electromechanical motor or generator of any of Embodiments 1 through 8, wherein the first component comprises the electrical coil, and wherein the second component comprises the magnet.

### Embodiment 10

The electromechanical motor or generator of any of Embodiments 1 through 9, wherein the second component comprises a plurality of permanent magnets.

### Embodiment 11

The electromechanical motor or generator of Embodiment 1, wherein the sleeve comprises a ceramic-metal composite material, the metal portion of the sleeve comprising a metal phase of the ceramic-metal composite material, the non-magnetic and non-conductive portion of the sleeve comprising a ceramic phase of the ceramic-metal composite material.

### Embodiment 12

The electromechanical motor or generator of any of Embodiments 1 through 11, wherein the metal portion of the sleeve comprises at least one of a titanium-based alloy, a nickel-based alloy, or non-magnetic steel.

### Embodiment 13

The electromechanical motor or generator of any of Embodiments 1 through 12, wherein the electromechanical motor or generator is configured to use in a downhole tool.

### Embodiment 14

A downhole system for use in a wellbore in a subterranean formation, comprising a hydraulic pump configured to pump fluid through a wellbore and an electromechanical generator configured to generate electricity responsive to flow of the fluid pumped through the wellbore by the hydraulic pump. The generator comprises a body, a stator, a drive element responsive to the flow of fluid, a rotor, and a sleeve disposed concentrically between the rotor and the stator and contacting the body such that the stator is hermetically sealed between the body and the sleeve. The stator comprises an electrical coil. The rotor comprises a magnet.

### Embodiment 15

A method of forming electromechanical motor or generator, comprising disposing a first component on a body, disposing a sleeve concentrically around the first component and hermetically sealing the first component between the body and the sleeve, and disposing a second component concentrically around the sleeve and the first component, and in operable proximity to the first component. The first component comprises one of a rotor and a stator and comprising one of a magnet and an electrical coil. The second component comprises comprising the other of the rotor and the stator and comprising the other of the magnet and the electrical coil. The sleeve comprises at least one metal portion and at least one non-magnetic and non-conductive portion.

### Embodiment 16

The method of Embodiment 15, wherein hermetically sealing the first component between the body and the sleeve comprises sealing the first component at atmospheric pressure.

### Embodiment 17

The method of Embodiment 15 or 16, further comprising selecting the at least one non-magnetic and non-conductive portion to comprise a ceramic tube.

### Embodiment 18

The method of any of Embodiments 15 through 17, further comprising selecting the at least one metal portion to comprise a metal tube disposed concentrically about the ceramic tube.

### Embodiment 19

The method of any of Embodiments 15 through 18, wherein the sleeve comprises a ceramic-metal composite material, the metal portion of the sleeve comprising a metal phase of the ceramic-metal composite material, the non-magnetic and non-conductive portion of the sleeve comprising a ceramic phase of the ceramic-metal composite material.

### Embodiment 20

The method of any of Embodiments 15 through 19, wherein the metal portion of the sleeve comprises at least one of a titanium-based alloy, a nickel-based alloy, or non-magnetic steel.

Although the present disclosure has described embodiments of the sleeve 100, 200 employed in an electromagnetic motor or generator 30, the disclosure is not so limited. Various embodiments of the sleeve 100 may be employed in various applications in which providing a protected environment using a protective sleeve exhibiting a reduction in eddy current losses is desirable. While the disclosed device structures and methods are susceptible to various modifications and alternative forms in implementation thereof, specific embodiments have been shown by way of example in the drawings and have been described in detail herein. However, it should be understood that the present invention is not intended to be limited to the particular font's disclosed. Rather, the present invention encompasses all modifications, combinations, equivalents, variations, and alternatives falling within the scope of the present disclosure as defined by the following appended claims and their legal equivalents.

1. An electromechanical motor or generator, comprising:
a body;
a first component disposed on the body, the first component comprising one of a rotor and a stator and comprising one of a magnet and an electrical coil;
a second component disposed concentrically around and in operable proximity to the first component, the second component comprising the other of the rotor and the stator and comprising the other of the magnet and the electrical coil; and
a sleeve disposed concentrically between the second component and the first component and contacting the body such that the first component is hermetically sealed between the body and the sleeve, the sleeve comprising:
at least one metal portion; and
at least one non-magnetic and non-conductive portion.

2. The electromechanical motor or generator of claim 1, wherein the at least one non-magnetic and non-conductive portion comprises a ceramic tube, and wherein the first component is disposed at least substantially within the ceramic tube.

3. The electromechanical motor or generator of claim 2, wherein the at least one metal portion comprises a metal tube disposed concentrically about the ceramic tube.

4. The electromechanical motor or generator of claim 3, wherein the at least one metal portion further comprises a first longitudinal metal end portion and a second longitudinal metal end portion, and wherein each of the ceramic tube and the metal tube extends longitudinally between the first longitudinal metal end portion and the second longitudinal metal end portion.

5. The electromechanical motor or generator of claim 4, wherein each of the first longitudinal metal end portion and the second longitudinal metal end portion is bonded to the metal tube such that the ceramic tube is captured and enclosed within the metal portion of the sleeve.

6. The electromechanical motor or generator of claim 1, wherein the at least one metal portion of the sleeve has a first linear coefficient of thermal expansion at room temperature, the at least one non-magnetic and non-conductive portion of the sleeve has a second linear coefficient of thermal expansion at room temperature, the second linear coefficient of thermal expansion being between about 90% and 110% of the first linear coefficient of thermal expansion.

7. The electromechanical motor or generator of claim 1, further comprising a first seal member disposed between a first longitudinal end of the sleeve and the body, and a second seal member disposed between a second longitudinal end of the sleeve and the body.

8. The electromechanical motor or generator of claim 1, wherein the non-magnetic and non-conductive portion of the sleeve comprises a ceramic portion or a polymer portion.

9. The electromechanical motor or generator of claim 1, wherein the first component comprises the electrical coil, and wherein the second component comprises the magnet.

10. The electromechanical motor or generator of claim 1, wherein the second component comprises a plurality of permanent magnets.

11. The electromechanical motor or generator of claim 1, wherein the sleeve comprises a ceramic-metal composite material, the metal portion of the sleeve comprising a metal phase of the ceramic-metal composite material, the non-magnetic and non-conductive portion of the sleeve comprising a ceramic phase of the ceramic-metal composite material.

12. The electromechanical motor or generator of claim 1, wherein the metal portion of the sleeve comprises at least one of a titanium-based alloy, a nickel-based alloy, or non-magnetic steel.

13. The electromechanical motor or generator of claim 1, wherein the electromechanical motor or generator is configured for use in a downhole tool.

14. A downhole system for use in a wellbore in a subterranean formation, comprising:
a hydraulic pump configured to pump fluid through a wellbore; and
an electromechanical generator configured to generate electricity responsive to flow of the fluid pumped through the wellbore by the hydraulic pump, the generator comprising:
a body;
a stator comprising an electrical coil and disposed on the body;
a drive element rotatable responsive to the flow of fluid;
a rotor comprising a magnet, coupled to the drive element and disposed concentrically around in operable proximity to the stator; and
a sleeve disposed concentrically between the rotor and the stator and contacting the body such that the stator is hermetically sealed between the body and the sleeve, the sleeve comprising at least one metal portion and at least one non-magnetic and non-conductive portion.

15. A method of forming electromechanical motor or generator, comprising:
disposing a first component on a body, the first component comprising one of a rotor and a stator and comprising one of a magnet and an electrical coil;
disposing a sleeve concentrically around the first component and hermetically sealing the first component between the body and the sleeve, the sleeve comprising at least one metal portion and at least one non-magnetic and non-conductive portion; and
disposing a second component concentrically around the sleeve and the first component, and in operable proximity to the first component, the second component comprising the other of the rotor and the stator and comprising the other of the magnet and the electrical coil.

16. The method of claim 15, wherein hermetically sealing the first component between the body and the sleeve comprises sealing the first component at atmospheric pressure.

17. The method of claim 15, further comprising selecting the at least one non-magnetic and non-conductive portion to comprise a ceramic tube.

18. The method of claim 17, further comprising selecting the at least one metal portion to comprise a metal tube disposed concentrically about the ceramic tube.

19. The method of claim 15, wherein the sleeve comprises a ceramic-metal composite material, the metal portion of the sleeve comprising a metal phase of the ceramic-metal composite material, the non-magnetic and non-conductive portion of the sleeve comprising a ceramic phase of the ceramic-metal composite material.

20. The method of claim 15, wherein the metal portion of the sleeve comprises at least one of a titanium-based alloy, a nickel-based alloy, or non-magnetic steel.
